(19) United States
(12) Patent Application Publication
(10) Pub. No.: US 2022/0170301 A1
(43) Pub. Date: Jun. 2, 2022

(54) CARGO CONTAINMENT STRUCTURE 360 DEGREE DOOR SYSTEM

(71) Applicant: JOHN B LAMPSA, WALES, WI (US)

(72) Inventor: JOHN B LAMPSA, WALES, WI (US)

(21) Appl. No.: 17/674,456

(22) Filed: Feb. 17, 2022

Related U.S. Application Data
(63) Continuation-in-part of application No. 15/809,533, filed on Nov. 10, 2017.
(60) Provisional application No. 62/420,166, filed on Nov. 10, 2016.

(51) Int. Cl. E05D 3/12; B60J 5/10

(52) U.S. Cl. CPC E05D 3/12; E05B 83/08; B60J 5/108

(57) ABSTRACT

A semi-trailer structure swinging door system having one or more doors capable of swinging on double pivoting joints such that said door or doors can be opened both outward of the cargo containment structure and inward into the cargo containment structure. Various aspects of the joint provide for the joint as an insert and the joint having a sigmoid shape construction; the doors are capable of being secured by a latching mechanism in a closed position.

### RELATED APPLICATION

This application is a continuation-in-part of co-pending application Ser. No. 15/809,533 filed 10 Nov, 2017, which claims the benefit of Provisional Patent Application Ser. No. 62/420,166, filed 10 Nov. 2016.

### BACKGROUND OF THE INVENTION

The present invention pertains to the functionality of the door or doors found on a cargo containment structure such as on a semi-trailer. In particular, the present invention realties to an improved joint for rotation of semi-trailer doors. Semi-trailers are typically used to haul cargo from one location to another. The trailer is typically coupled to a semi-truck when moved from one location to another. The present invention may also pertain to the functionality of the door or doors on a straight van body style truck or cargo container attached to a semi-trailer as well.

A semi-trailer has one or more doors located on the back side of the trailer. A straight van body style truck and cargo container may have the same door configuration. In transit, the door or doors are closed. The doors are opened when cargo is placed into or removed from the trailer, truck or container.

There are two common styles of doors used on semi-trailers and straight van body style trucks. The first is a roll-up door comprised of multiple horizontal door segments that are hingedly attached to one another along their upper and lower edges. This type of door is guided by rollers on its outward left and right edges. The rollers fit within tracks attached to the sides and roof of the semi-trailer adjacent and above its rear opening. When opened, the door moves upward and curves along its hinged segments as it bends from a generally vertical position to a generally horizontal position in the ceiling of the trailer (substantially parallel with the trailer roof). The second style door is a swinging door, also sometimes referred to as a barn door. A semi-trailer typically has two swinging doors, although only one door could be used in some applications. Each swinging door is hingedly attached to the vertical edge of the trailer's back side and the pair of doors meet at the center of the back side. In a single door application, the single door extends from one vertical edge of the trailer's back side to the opposite vertical edge. The present invention is an improvement to the swinging or barn style door configuration.

Known swinging semi-truck trailer and cargo container doors swing only outward from the back side of the trailer or container through an arc of almost 270 degrees and then rest against, or are temporarily fastened to, the outer sides of the semi-trailer or cargo container. The hinges used on each door, as well as structural elements of the trailer's construction prevent the doors from swinging inward into the interior of the trailer. The same holds true for a cargo container.

Because a sufficient amount of space is required behind and next to the trailer to open each swinging door, the trailer doors must be opened before the trailer is positioned at a loading dock. Through the use of leveling devices, the heights of most loading docks are adjusted to be at substantially the same level as the trailer floor. This allows the use of wheeled equipment, such as fork lift trucks and dollies, to be driven from the dock into the trailer to load or unload cargo. In addition, loading docks are often spaced one right next to the other with a minimal amount of space between parked semi-trailers. Once the semi-trailer is positioned at the dock, there is insufficient clearance for the swinging doors to be opened or closed.

When the semi-trailer is ready to be loaded or unloaded with cargo, the trailer is backed against a loading dock. Before the truck driver positions the trailer against the dock, the driver must first open the semi-trailer doors. At present, the driver must stop the semi-truck in an area away from the loading dock, get out of the truck cab, open (and secure) each trailer door, get back in the cab and then back the trailer into position at the loading dock. Similarly, once the trailer has been filled with cargo, the driver must pull away from the loading dock, get out of the truck cab, close and secure the trailer doors and get back in the cab.

There is a need for a semi-trailer door other than a roll-up style door that can be opened and/or closed after the trailer is positioned at the loading dock. Roll-up style doors require a significant amount of maintenance, require a bending motion for opening and a reaching motion for closing that can cause injury to the operator and have a low header clearance due to the door tensioner and door storage requirements when the door is open. Thus, as compared to the prior art doors which only open outwardly or roll-up, a need exists for a door would also reduce the degree of bending required by the operator to open and close the doors. Further, the overhead tensioner spring and cable of the roll-up style doors are prone to failure. Such a failure may result in severe injury to the operator when an open roll-up style door advances downward due to a failure in the aforementioned assembly. A need exists to provide an ergonomic solution reducing the factors leading to such an injury prone scenario.

Where the concerns of the type of door are addressed, a joint assembly having a reduced exposure to the environment would allow for rotation of the door without risk of destruction of the joint, allowing for the rotation of the door, from environmental factors such as other semi-trailers or loading dock walls.

There is a need for a semi-trailer door where someone other than the driver can open and close the semi-trailer door.

There is need for a semi-trailer door that can be secured in its closed position before the semi-truck and trailer leave the loading dock.

There is a need for a semi-trailer door that does not require a truck driver to exit the truck to open or close the trailer door before backing the trailer into the docking area.

There is a need for a semi-trailer door that optimizes ergonomic movement of the operator, reducing the possibility of injury to the operator from a bending motion.

There is a need for a semi-trailer door that reduces factors leading to injuries caused by failure of the mechanics of door assemblies.

There is a need for a joint assembly having a reduced exposure to the environment for attaching doors to semi-trailers.

Similar needs exist for cargo container's as well, especially cargo containers that are attached to semi-trailers for the pick-up and delivery of goods.

### SUMMARY OF THE INVENTION

The present invention comprises a swinging door system for a semi-trailer having one or more swinging or barn doors capable of swinging both outward of the semi-trailer and inward into the semi-trailer. The doors are capable of being secured by a latching mechanism in a closed position.

The semi-trailer structure comprises a door frame, which is provided by at least two side walls of the semi-trailer and an associated framing. At least one door is in communication with the door frame. At least two joints are in unitary one-piece construction with, attaching, or in coupled communication with each of, at least one door and the door frame. The joints comprise a first pivot point and a second pivot point, whereby the at least one door can be opened into or out of the semi-trailer structure. This semi-trailer door orientation of the invention optimizes ergonomic movement of the operator, reducing the possibility of injury to the operator from a bending motion.

The door system of the present invention further comprises a pair of swinging or barn doors, two or more joints attaching each door and the semi-trailer and a locking mechanism.

In a preferred embodiment, the door system of the present invention comprises a pair of semi-truck trailer swinging or barn doors, two or more joints coupling each door and the trailer and a locking mechanism.

In another preferred embodiment, the door system of the present invention comprises a pair of cargo container swinging or barn doors, two or more double hinges coupled between each door and the container and a locking mechanism.

The back side of a semi-trailer has a rectangular shaped opening formed by its side walls, floor and roof. The framing provides for extensions along each vertical side of the opening. Mating, extensions are provided for on an edge face of the door, where the edge face separates an interior panel of the door and the opposite exterior panel of the door. Each extension comprises an extension pivot bore extending substantially parallel to the vertical side of the opening. A connector is positioned above mating extensions of the frame and door. The orientation of the door to the frame reduces factors leading to injuries caused by failure of the mechanics of door assemblies. The connector has two pivot openings. One pivot opening substantially aligns with the extension through bore of the door and the second pivot opening of the connector substantially aligns with the extension through bore of the frame. A second connector is mated with the respective extensions below the extensions in the manner described for the first extension. A pivot pin is positioned through each respective grouping of the extension through bore and the pivot openings of the two connectors. Thus, each swinging door is hingedly supported on the back side of the semi-trailer. The construction and utilization of each extension and connector combination allows the semi-trailer door to swing outwardly or inwardly relative to the opening in the rear side of the cargo containment structure.

A second aspect of the invention provides the extensions of the door and frame as removable inserts housed in cavities of the respective door and frame.

A third aspect of the invention substitutes the extensions for a connector cavity in the frame and a mating connector cavity in the door. Each cavity is defined by two opposite vertically opposed wells. A connector, having two connector through bores, is positioned within the mating connector cavities. A pin is positioned through the connector through bore positioned in the door connector cavity. The ends of the pin are housed within the opposite wells defining the cavity. The same occurs for the connector through bore positioned in the door frame connector cavity. The ends of such pin are positioned in the wells defining the connector cavity of the door frame.

A fourth aspect of the invention provides for a door system for a semi-trailer defined by at least one substantially vertical semi-trailer side wall with an interior side and an opposite exterior side, the door system comprising: a door frame defined by the side wall; the door frame has a face substantially perpendicular to said side wall; at least one door having a door interior side and a door exterior side; at least one movable joint is in coupled communication with the door frame face and the door; the at least one joint has a first pivot point and a second pivot point; the first pivot point and the second pivot point are pivotally connected with a sigmoid shaped connector; and the door is pivotally positioned from a first position with the door interior side adjacent to and substantially parallel to the semi-trailer side wall interior side to a second position with the door exterior side adjacent to and substantially parallel to the semi-trailer side wall exterior side.

The invention further provides for: a plurality of the at least two joints being in coupled communication with the door and the door frame face; the first pivot point and the second pivot point are offset in a longitudinal direction with respect to the side wall; the first pivot point is offset in a first traverse direction with respect to the sidewall; the second pivot point is offset in a second traverse direction, opposite the first traverse direction; the sigmoid connector has a first bend extending towards the first pivot point and a second bend extending opposite the first bend towards the second pivot point; at least one of the first bend and the second bend is defined by at least one of a crescent shape and an angular extension.

As described above, the present invention utilizes double pivoting joints. Each extension may be in unitary one-piece construction with, or mounted to, the semi-trailer structure opening and to each door. Unlike a traditional hinge with a single pivot point, each double pivoting joint includes a first pivot point and a second pivot point. The first and second pivot points allow the swinging door to pivot about at least one of the first pivot and second points when either opened in the outward direction or opened in the inward direction.

### BRIEF DESCRIPTION OF THE DRAWINGS

FIG. 1 is a perspective view of a rear portion of a semi-trailer including the 360 degree door system;

FIG. 2 is a rear elevation view of a semi-trailer including the 360 degree door system;

FIG. 3 is a perspective view of the latch mechanism shown in FIG. 1;

FIG. 4 is a rear elevation view of a semi-trailer similar to FIG. 2, but depicting an alternate latch mechanism;

FIG. 5A is a cut-away top plan view of a semi-trailer including the 360 degree door system with the doors closed;

FIG. 5B is an enlarged perspective view of the semi-trailer 360 degree door system of FIG. 4A;

FIG. 5C is an enlarged view of the semi-trailer 360 degree door system of FIG. 4A;

FIG. 6 is a cut-away top plan view of a semi-trailer including the 360 degree door system with the doors partially open outwardly;

FIG. 7A is a cut-away top plan view of a semi-trailer including the 360 degree door system with the doors fully open outwardly;

FIG. 7B is an enlarged perspective view of the semi-trailer 360 degree door system of FIG. 7A;

FIG. 7C is an enlarged view of the semi-trailer 360 degree door system of FIG. 7A;

FIG. 8A is a an enlarged view of the semi-trailer including the 360 degree door system with the doors fully open inwardly;

FIG. 8B is an enlarged perspective view of the semi-trailer 360 degree door system of FIG. 8A;

FIG. 8C is an enlarged view of the semi trailer door hinge system of FIG. 8A;

FIG. 9A is an enlarged exploded view of the joint of the 360 degree door system;

FIG. 9B is an enlarged exploded view of a second aspect of the joint of the 360 degree door system;

FIG. 10A is an enlarged perspective view of a third aspect of the joint of the 360 degree door system;

FIG. 10B is an enlarged exploded view of the third aspect of the joint of the 360 degree door system;

FIG. 11 is an enlarged exploded view of the third aspect of the joint of the 360 degree door system, illustrating rounding of aspects of the joint and semi-trailer.

FIG. 12 is a perspective view of a rear portion of the semi-trailer including a fourth aspect of the joint of the 360 degree door system;

FIG. 13 is a frontal perspective view of the fourth aspect of the joint of the 360 degree door system;

FIG. 14 is a rear perspective view of the fourth aspect of the joint of the 360 degree door system;

FIG. 15 is an enlarged view of the 360 degree door system of FIG. 12 with the door closed;

FIG. 16 is an enlarged view of the 360 degree door system of FIG. 12 with the door fully open inwardly;

FIG. 17 is an enlarged view of the 360 degree door system of FIG. 12 with the door partially open outwardly;

FIG. 18 is an enlarged view of the 360 degree door system of FIG. 12 with the door fully open outwardly.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention.

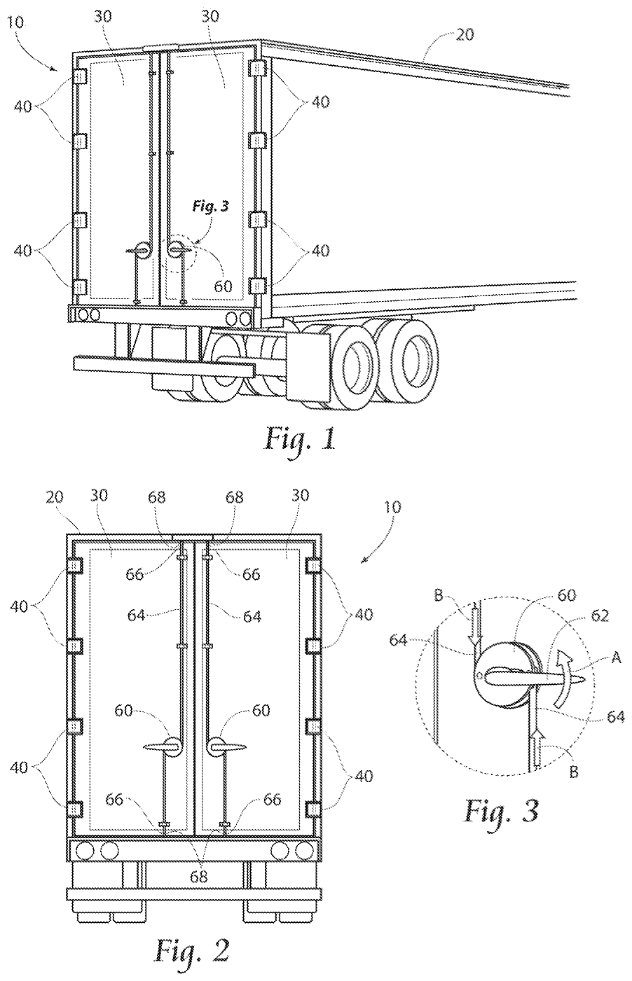

Referring to FIGS. 1 and 2, a semi-trailer 20 of the type to which the present invention 10 is applicable is illustrated. It is to be understood and appreciated that the invention 10 has numerous applications to other types of truck trailers, to cargo containers, to straight van body style trucks, to refrigerated trailers and truck bodies, etc. As shown in FIG. 1, a pair of doors 30 are hingedly supported on a plurality of double pivoting joints 40. While four joints are shown, the number could be greater or less, depending upon the specific application.

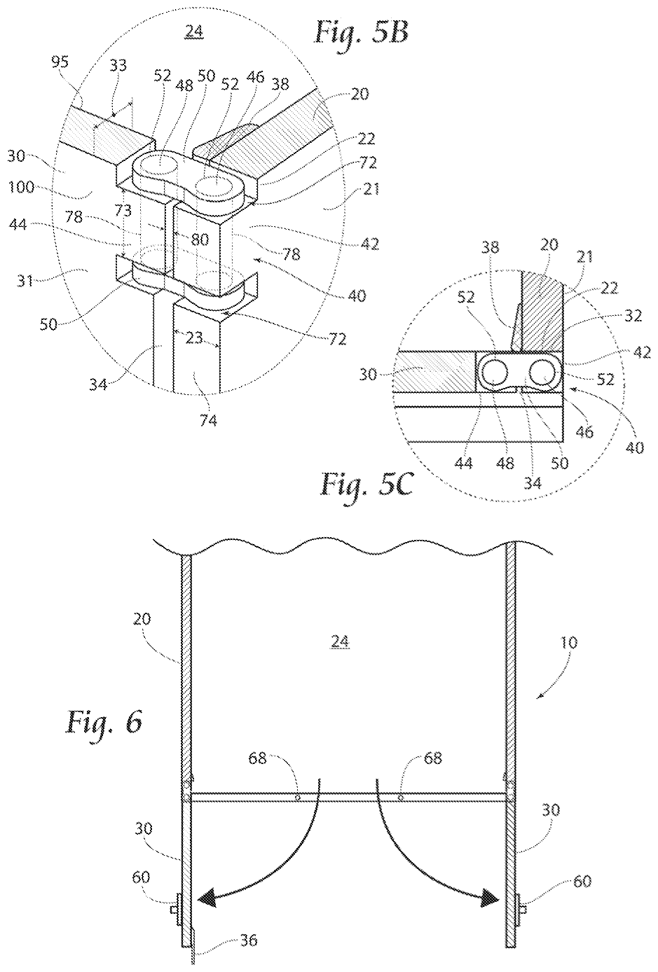

Now referring to FIGS. 1 to 3, the invention 10 further includes one or more latching mechanisms 60 for securing each door 30 in a closed position. Referring specifically to FIG. 3, rotation of the latch mechanism handle 62 in the direction shown by the arrow A moves locking bars 64 in the direction shown by arrows B thereby disengaging the ends 66 of locking bars 64 from their locking openings 68 (best shown FIGS. 5-7) thereby allowing each unlatched door 30 to swing in the desired direction. It is important to note that the desired direction can be either outwardly of the semi-trailer 20 or inwardly of the semi-trailer 20.

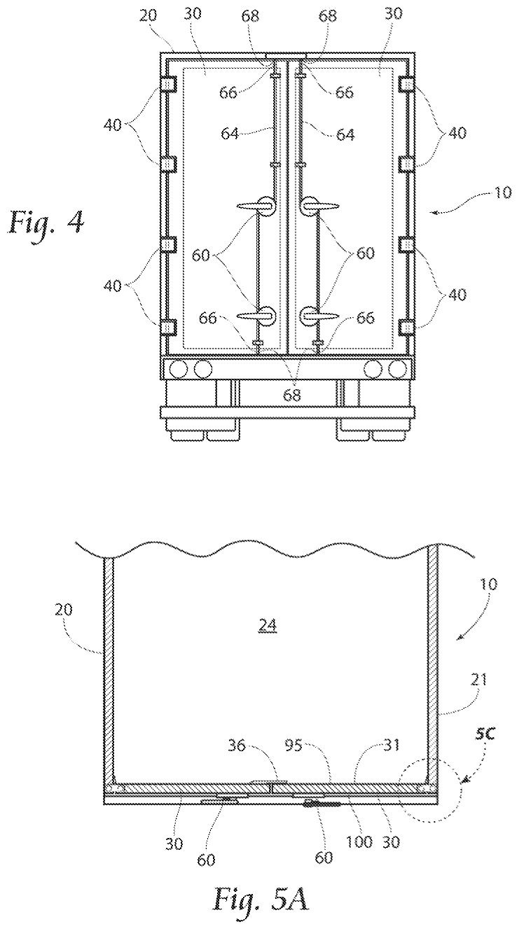

Referring to FIG. 4, a rear elevation view of the back side of a semi-trailer 20 utilizing the present invention 10 is illustrated. An alternate or dual latching mechanism 60 is shown. The alternate mechanism provides a first or lower latching mechanism 60 on each trailer door 30 and a second or upper latching mechanism 60 on the same trailer door 30. The upper and lower latching mechanisms 60 allow for the driver to release or engage the door latch 60 utilizing the lower mechanism when standing on the ground and a dock worker to release or engage the door latch when standing on the loading dock. Neither trailer door operator (driver or dock worker) is thus required to reach over his or her head or stoop toward the ground to operate the latch mechanism 60. It has been shown that both of these motions can lead to potential injuries to the operator.

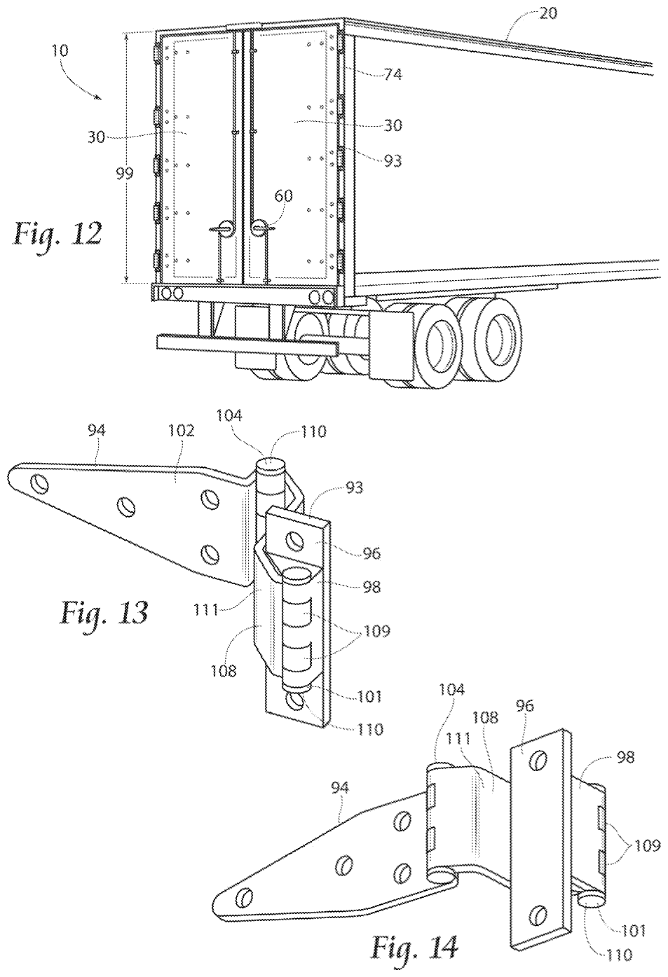

FIG. 5A is a cut-away top plan view of the trailer 20 and doors 30 in a closed position including the location of double pivoting joints 40. Further, FIGS. 5B and 5C depicts an embodiment of the double pivoting joints 40. The double pivoting joint 40 includes a first extension 42, a second extension 44, a first pivot pin 46, a second pivot point 48 and a pair of connectors 50. Each double pivoting joint 40 has the first extension 42 protruding from the semi-trailer door frame 22 and the second extension 44 protruding from the swinging door 30. The first extension 42 is in unitary one-piece construction with the door frame 22, and is part of the door frame 22 as such. The first extension 42 is defined by two substantially parallel grooves 72 in the door frame 22, separated by a groove separation distance 73 along the door frame length, see FIG. 12, Each groove 72 starts at a door frame back edge face 74 and extending towards the semi-trailer wall 21 on which the frame 22 is attached. The back edge face 74 defines the back of each of the semi-trailer 20 and the semi-trailer door frame 22. Each groove 72 extends at least part of a door frame width 23 of the door frame 22, and preferably the width of the door frame 23. The section of the door frame 22 between the parallel grooves 72 is the first extension 42. Similar to the first extension 42, the second extension 44 is defined by two substantially parallel grooves 72 in the door 30, separated by a groove separation distance 73 along the door 30 in substantially the same orientation as the grooves 72 defining the first extension 42. Each groove 72 starts at the door edge face 34 of the respective door 30 and extending towards and into the door body 31 of the respective door 30. The edge face 34, which has a door width 33, separates the side of the door. As illustrated in FIGS. 5A and 5B, the door has a door interior side 95, facing the interior cargo compartment 24 of the semi-trailer 20 when the door is in a closed position as in FIGS. 5A to 5B, and a door exterior side 100 which faces the outside environment when the door is in a closed position as in FIGS. 5A to 5B. Each groove 72 extends at least part of a door width 33 of the door 30, and preferably the width of the door 33. The section of the door 30 between the parallel grooves 72 is the second extension 44. The pivot pins 46, 48 pass through extension pivot bores 78 in the in the extensions (42, 44).

The pins (46, 48) extend out the respective bore 78 for each pin (46, 48). A connector 50 is positioned in a first groove 72 of the door frame and the mating first groove 72 of the door. The connector 50 has at least two pivot openings 52. Each pivot opening 52 receives the pin (46, 48) for which the respective opening 52 is at least substantially closely aligned. A connector 50 is positioned in the second groove 72 of the door frame and the mating second groove 72 of the door. Each pivot opening 52 of the connector 50, positioned in the second grooves 72 for the door 30 and the door frame 22, receives the pin (46, 48) for which the respective opening 52 is at least substantially closely aligned. The pins (46, 48) are preferably attached to the connectors 50 in which the respective pin (46, 48) communicates at the opening 52 in which the respective pin (46, 48) is inserted. Alternatively, the pins (46, 48) are not attached to such connectors 50. The relationship of the pin (46, 48) to the bore 78, and opening 52 where applicable, allows for pivotable rotation of the pin (46, 48) with the respective bore, and opening 52 where applicable. This rotation, provides for a 360 degree rotation of the door 30. As illustrated in FIG. 5A, a door seal 38 may also be provided to prevent dust, dirt, debris or other foreign matter from entering into the trailer 20 cargo compartment 24 when the doors 30 are in their closed position.

Referring to FIGS. 5B and 5C, the relationship of the first extension 42 and the second extension 44 provides for an extension separation 80. This separation 80 allows for the 360 degree rotation of the joint 40 by providing a separation for the door 30, edge face 34 and door panels as a unit, to rotate inwardly into the trailer compartment 24 and outward to the exterior of the trailer 20.

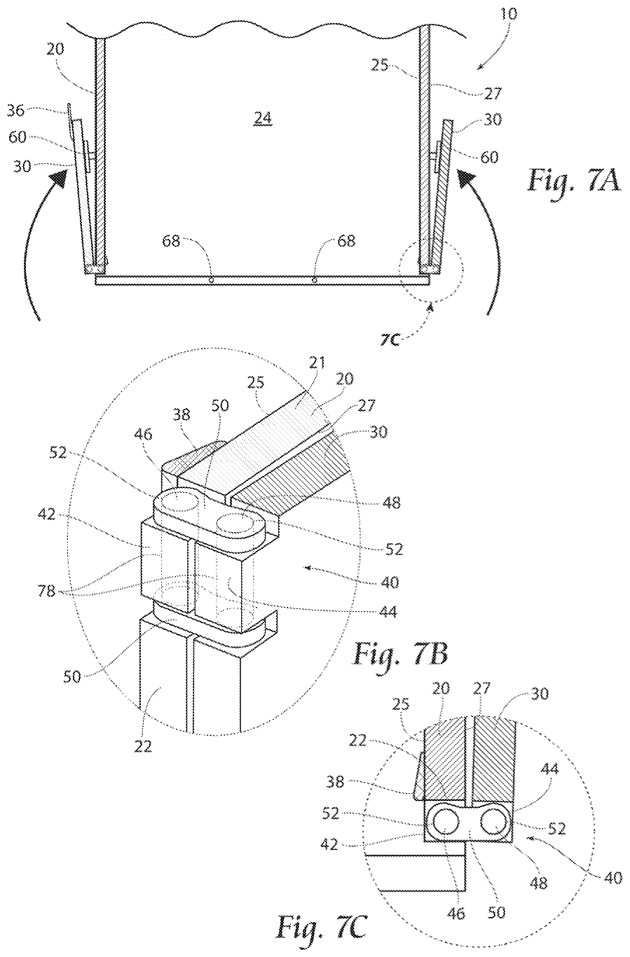

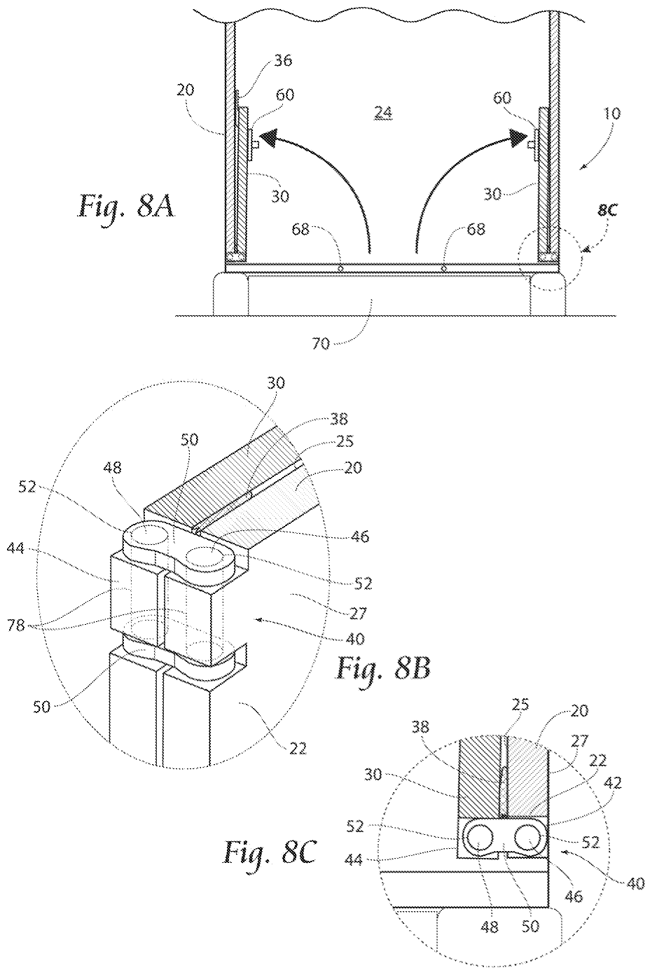

The doors 30 of the present invention can be opened in the traditional manner as shown FIGS. 6 and 7A. The doors 30 are swung outward of the trailer 20 to allow access to the trailer interior 24 via its back side. The doors 30 may be open partially (FIG. 6) or completely (FIG. 6A). Opening the doors 30 to the partial position of FIG. 6 is provided with rotation of each respective door 30, including the extension 44, about the pins (46, 48), causing the connectors 52 to rotate to a second position while pivoting about the bore 78 of the first extension 42. The door position shown in FIG. 6 is not feasible for loading and unloading of the trailer 20 from a loading dock 70, see FIG. 8A, as the position of the doors will not allow the trailer 20 to be positioned immediately adjacent to the loading dock such that wheeled equipment, such as dollies and fork lift trucks can be used to add or remove cargo from within the trailer 20.

The position of the doors in FIG. 7A is the position required in the prior art when the trailer 20 is backed to a loading dock 70, see FIG. 8A. Opening the doors 30 to the fully open position of FIG. 7A is provided with rotation of each respective door 30, including the extension 44, about the respective pins (46, 48). In doing so, rotation of the door 30 occurs about both pins (46, 48). Further, the connectors 52 rotate to a third position while pivoting about the bore 78 of the first extension 42. As illustrated in FIGS. 7B and 7C, the position of the double pivoting joint 40 is depicted when the doors 30 have been swung fully open, adjacent to and substantially parallel to the sides of the trailer 20, specifically the exterior side 27 of the side wall 21 of the trailer 20. This rotation of the doors 30 moves the doors 30 to their outwardly open position typically required before the trailer 20 is backed adjacent to a loading dock 70. It is observed the side wall 21 of the trailer 20 has an exterior side 27 and an opposite interior side 25, where the interior side 25 faces the cargo compartment 24, see FIG. 7A, when the door 30 is in the closed position.

As best illustrated in FIGS. 5A, 7A and 8A, it will also be noted that one of the doors 30 may include a stop plate 36 attached to its inner surface. The function of the stop plate 36 is to provide a stop surface and seal between the doors 30 in their closed and latched position, see FIG. 5A.

Further referring to FIG. 8A, each door 30 in its inwardly swung open position, addressing the deficiencies of the prior art. Opening the doors 30 in this manner allows the driver of the semi-truck (not shown) to which the semi-trailer 20 is coupled the ability to back up to a loading dock 70 without having to first stop the truck, exit the truck, open the trailer doors 30 in the outward direction (as shown in FIG. 7A), get back in the truck and finish backing the trailer 20 toward the loading dock 70. FIGS. 8B and 8C depicts the joint 40 position when the doors 30 are in their fully opened and inward swung position. Specifically, the door 30 is pivotally positioned adjacent to and substantially parallel to the interior side 25 of the side wall 21 of the trailer 20. Unlike the door positions shown in FIGS. 5A and 7A, it is to be appreciated that even though the trailer 20 is positioned adjacent to the loading dock 70, see FIG. 8A, employing the joint 40 makes it possible to open (and close) each semi-trailer door 30 by swinging it inwardly into the cargo area of the trailer (and then outwardly to the closed position) without the need to reposition or relocate the trailer relative to the loading dock 70, see FIG. 8A, by rotation of the respective door 30, and extension 44 about the pin 48. Further, the design of the invention 10, providing for inward opening of the doors 30, optimizes ergonomic movement of the operator, reducing the possibility of injury to the operator from a bending motion.

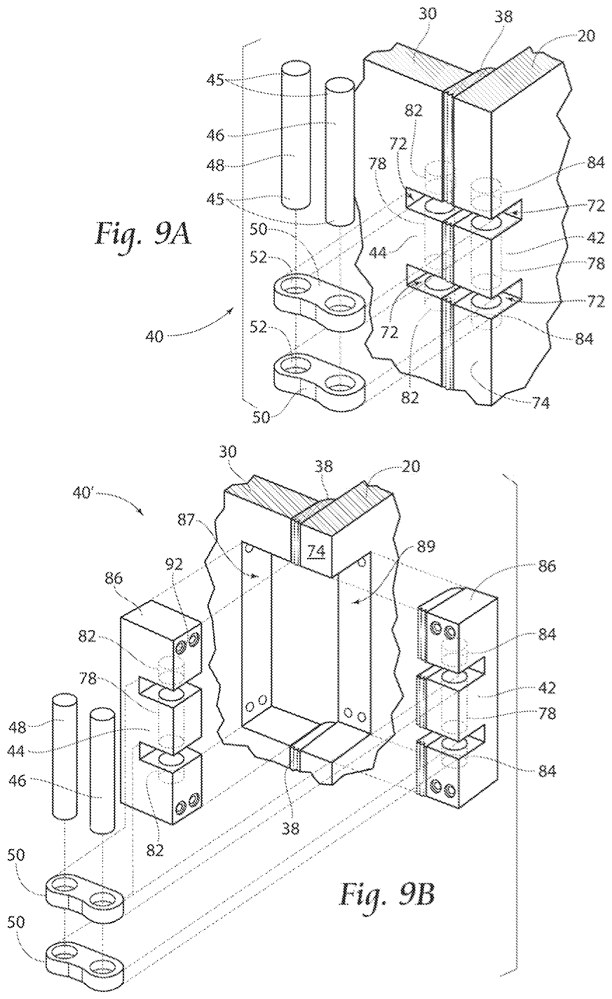

Referring to FIG. 9A, an enlarged exploded view of the joint 40 of the 360 degree door system 10 is illustrated. The pins (46, 48) are depicted as extending beyond the connectors while positioned in the respective bore 78 and through the connectors 50 as previously described. As to the door 30, the pin extensions 45 protrude beyond the connectors 50 for the pin 48 are housed in door pin bore wells 82. Housing the pin extensions 45 in the respective wells 82 allows for rotation and additional points of support for the rotation of the door 30 about the pin 48. As to the door frame 22, as with the pins 48 of the door 30, the pin extensions 45 of the pins 46 extend beyond the connectors 50 and are housed in door frame pin wells 84. Housing the pin ends 45 in the respective wells 84 allows for rotation and additional points of support for the rotation of the door 30 in a 360 degree motion.

Referring to FIG. 9B, an enlarged exploded view of a second aspect of the joint 40′ of the 360 degree door system 10 is illustrated. Incorporating the properties of the joint 40 as previously described, the joint 40′ is designed as a removable joint insert 86. As to the door 30, during operation of the joint 40′, the insert 86 is housed in a door cavity 87 such that the insert 86 is flush, or at least substantially flush, with the sides of the door 30. This orientation allows for increased wear resistance of the joint 40′ as compared to the prior art. The cavity 87 is constructed or machined from the door edge face and is equal to if not slightly larger than the dimensions of the insert 87. As a result, the insert 86 rests inside the cavity 87 of the door 30 with little or no vibrational or rotational movement. As to the door frame 22, during operation of the joint 40′, the insert 86 is housed in a door frame cavity 89 such that the insert 86 is flush, or at least substantially flush, with the sides of the door frame 30. This orientation allows for reduced increased wear resistance of the joint 40′ as compared to the prior art. The frame cavity 89 is constructed or machined starting at the door frame back edge face 74 and is equal to if not slightly larger than the dimensions of the insert 86. The inserts (84, 86) are anchored into the respective cavities (87, 89) with at least two bolts, screw or other mechanical attachment 92 allowing for removal of the inserts (84, 86) for replacement and or maintenance. As a result, the insert 86 rests inside the frame cavity 89 of the door frame 22 with little or no vibrational or rotational movement.

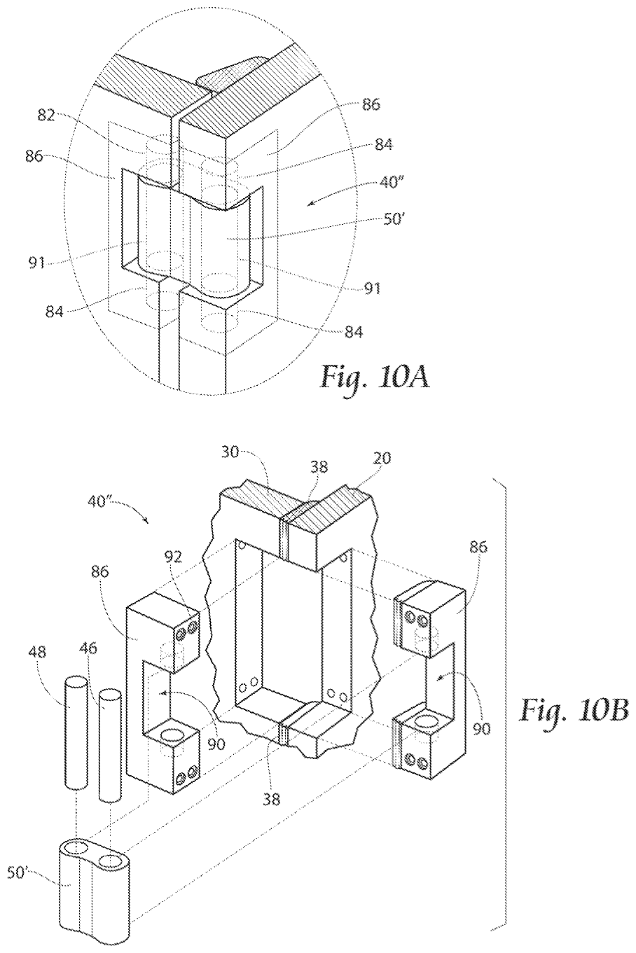

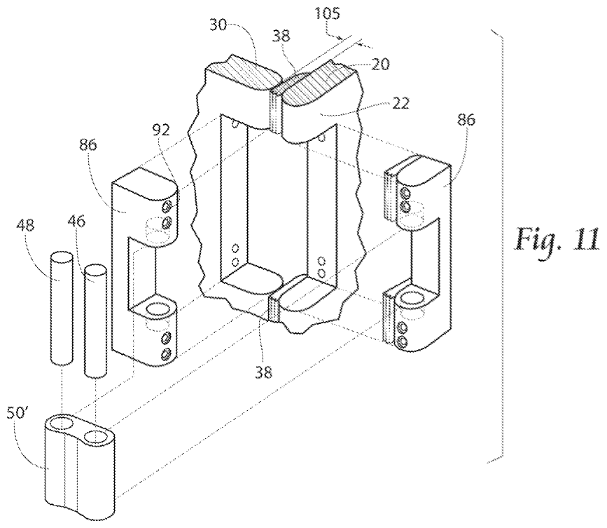

Referring to FIGS. 10A and 10B, a third aspect of the joint 40″ of the 360 degree door system 10 is described. Incorporating the properties of the joints (40, 40′) as previously described. With that, the joint 40″ is designed as a removable joint insert 86 as described in FIGS. 9A and 9B. Instead of providing for an extension (42, 44), each insert 86 provides for a connector cavity 90. The connector cavity 90 has a width of the insert 86, or substantially equal to that of the insert 86, and a connector cavity height. A second aspect of the connector 50′ is housed within the cavity 90. The connector 50′ preferably extends at least substantially the connector cavity height of the connector cavity 90. The connector 50′ houses two connector through bores 91. The pins (46, 48) are inserted through the through bores 91 and housed in their respective wells (82, 84). The connectors act to promote rotation of the door 30, as previously described, and maintain structural support of the door 30 with respect to the doorframe 22 as previously described.

Referring now to FIG. 11, the third aspect of the joint 40″ of the 360 degree door system 10 is further described, illustrating rounding of the joint 40″ and semi-trailer 20. Specifically, the door edge face 34, door frame back edge face 74, and the insert 86 rounded. The rounding of the respective surfaces provides for an increase in the distance between the door 30 and semitrailer 20 and an increase in the separation gap 105 between the door 30 and the door frame 22. The rounding provides a joint (40, 40′, 40″) having a reduced exposure to the environment, reducing the risk of damage to the joint (40, 40′, 40″). Further, the joint (40, 40′, 40″) reduces the possibility of environmental damages to the joints due to the compact design and integration of the design with the semi-trailer 20.

Referring to FIGS. 12, 13, 14 and 15, a fourth aspect of the joint 40″′ of the 360 degree door system 10 is described. Referring to FIG. 12, a semi-trailer 20 of the type to which the present invention 10, as previously described, is illustrated. As shown in FIG. 12, a pair of doors 30 are hingedly supported on a plurality of the fourth aspect of the joints 40′″. While four joints 40′″ are shown per door 30, the number could be greater or less, depending upon the specific application. The joint 40′″ is mounted at a first end 93 to the back edge face 74. At a second end 94 of the joint 40″′, the joint is mounted to the interior side 95 of the door 30.

Further referencing FIGS. 13, 14 and 15, with FIG. 13 illustrating a frontal perspective view of the joint 40′″ and FIG. 14 an opposite view, the joint 40″′ is further described. The first end 93 comprises a base plate 96 with at least two joint mounting holes. The base plate 96 may be bracketed, mounted or welded to the back edge face 74. An anchoring bracket 98 extends from the base plate 96, opposite the trailer 20 and the door frame 22. The bracket 98 preferably has a trapezoidal prism shape extending at least substantially parallel to the door frame length 99 of the door frame 22, see FIG. 12. Opposite the base plate 96 the bracket provides for the partial formation of the first pivot point 101.

The second end 94 of the joint 40″′ comprises a flat, or substantially flat, door mounting plate 102. The door mounting plate 102 is bracketed or mounted or welded, or a combination thereof, to the door interior side 95. The door mounting plate 102 comprises at least one joint mounting through hole, similar to that of the base plate 96 and may be used for mounting or bracketing the plate 102 to the door 30. Proximate to the base plate 96 and anchoring bracket 98, and following the portion of the plate mounted to the door edge face 34, see FIG. 5B, the mounting plate 102 provides for partial formation of the second pivot point 104.

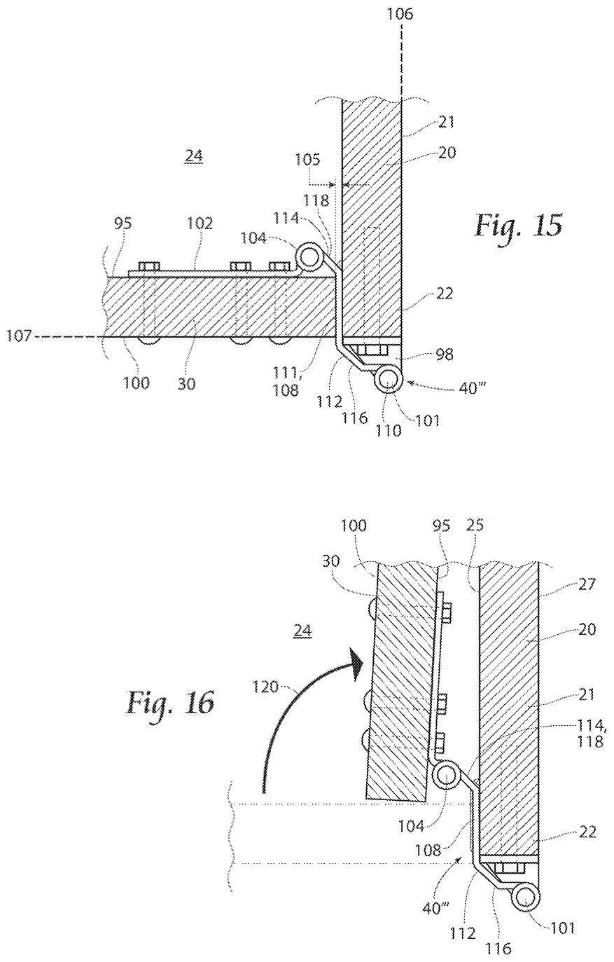

As illustrated in FIG. 15, the door 30 is in a closed position, similar to that illustrated in FIG. 5C. With that the first pivot point 101 is positioned outside of the trailer 20, and proximate to the door frame 22, the door 30 and the door-door frame separation gap 105. As with the extension gap 80, the separation gap 105 is a distance between the door 30 and door frame 22 where such a distance allows for movement of the door 30 in an opening and closing function. When the door 30 is in the closed position, as seen in FIG. 15, the second pivot point 104 is positioned within the cargo compartment 24 of the trailer 20 and proximate to the door frame 22, the door 30 and the door-door frame separation gap 105. With that, the first pivot point 101 and the second pivot point 104 are offset from one another in a longitudinal direction 106 with respect to the trailer wall, see FIGS. 15 and 16, because the first pivot point 101 is outside the trailer 20 and the second pivot point is within the compartment 24 when the door 30 is in the closed position. Further, the first pivot point 101 and the second pivot point 104 are offset from one another in a transverse direction 107 with respect to the trailer wall, see FIGS. 15 and 16, because the first pivot point 101 is in line with the trailer wall 21 of the trailer 20 which borders and defines the compartment 24, where the second pivot point is within the compartment 24, and proximate to the door 30, when the door 30 is in the closed position.

A connecting plate or series of plates 108 extends from the first pivot point 101 to the second pivot point 104. At each pivot point (101, 104) the connecting plate 108 provides for a series of connecting features 109, see FIG. 13, for creating a pivot point (101, 104). As for the first pivot point 101, the respective connection features 109, see FIG. 13, in close proximity to the bracket 98 are interwoven or combined with the bracket 98 to create the first pivot point 101. At pin 110 is provided to complete the pivot point 101. The same applies for creation of the second pivot point 104, where the connecting features 109 proximate to the mounting plate 102 and the mounting plate 102 are combined with the addition of a pin 110.

As noted, the pivot points (101, 104) are offset longitudinally and in the traverse direction. This offset in two directions nearly orthogonal to one another is what allows the joint 40″′ to provide for 360 degree rotation of the door 30 about the joint 40′″ and with respect to the trailer 20. In order to provide a connection between the offset pivot points (101, 104), the connecting plate provides for a sigmoid shape construction 111 along the longitudinal direction 106.

As illustrated in FIG. 15, with the sigmoid, or S-shape, construction 111 of the connecting plate 108, the connecting plate 108 extends along the longitudinal direction 106 with respect to the trailer 20 side wall 21. In close proximity to the first pivot point 101, the connecting plate 108 provides for a first connector bend 116 in a first traverse direction 112, with respect to the wall 21 of the trailer 20, extending the connecting features 109 in the first transverse direction 112 to provide for the first pivot point 101. In close proximity to the second pivot point 104, the connecting plate 108 provides for a second connector bend 118 in a second traverse direction 114, opposite or substantially opposite the first traverse direction 112, extending the connecting features 109 in the second transverse direction 114 to provide for the second pivot point 104. It is observed the bends (116, 118) may be crescent shaped or planar extensions at a predetermined angle with respect to the longitudinally central portion of the connecting plate 108.

Referring to FIGS. 15, 16, 17 and 18, the rotation and positioning of joint 40′″ while in operation with a door 30 on a semi-trailer 20 is described. As previously noted, FIG. 15 illustrates the positioning of the joint 40″′ when the door 30 is in the closed position, analogous to and incorporating features of FIGS. 5A to 5C. It is noted the connecting plate, extends through the separation gap 105 while the door 30 is in the closed position.

Referring to FIG. 16, analogous to and incorporating features as described in FIGS. 8A to 8C, the door 30 is rotated inward 120 with the door pivoting about the second pivot point 104 to extend into the compartment 24. In doing so, the interior side 95 of the door 30 is adjacent to and at least substantially parallel to the interior side 25 of the trailer wall 21 of the semi-trailer 20.

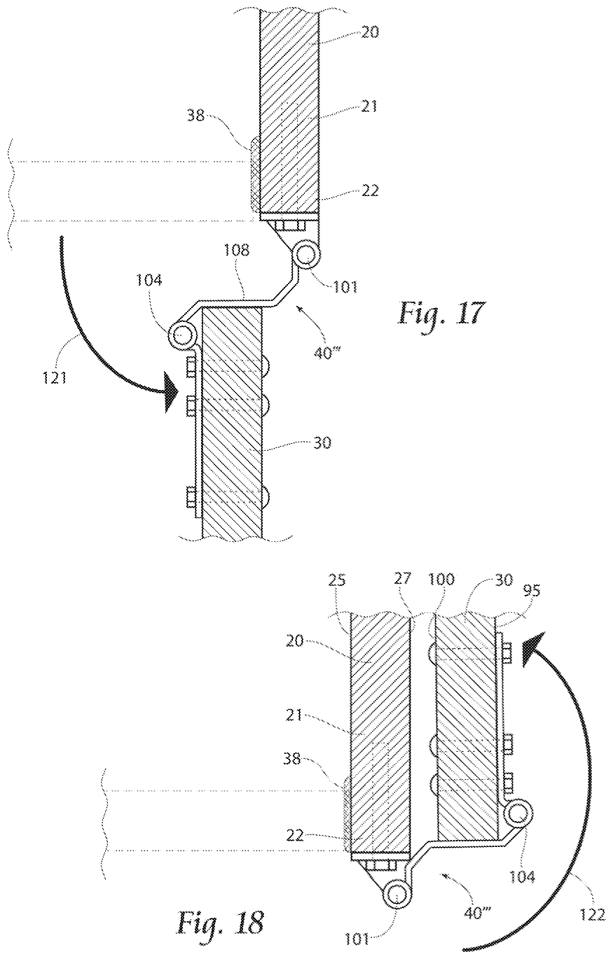

Referring to FIGS. 17 and 18, analogous to and incorporating the features of FIGS. 6 and 7A to 7C, the door 30 is rotated outward. In doing so, the door 30 remains substantially in the position with respect to the second pivot point 104 as is provided when the door 30 is in the closed position, see FIG. 15. As illustrated in FIG. 17, the door 30 is first rotated in an extended outward position 121 about the first pivot point 101 extending the door outward beyond the semi-trailer 20. The benefits and concerns expressed in the description of FIG. 6 apply to the application of the joint 40″′ to the door 30 and semi-trailer 20 in FIG. 17. As illustrated in FIG. 18, the door 30 is further rotated about the first pivot point 101 another 180 degrees 122. In doing so, the exterior side 100 of the door 30 is adjacent to and at least substantially parallel to the exterior side 27 of the side wall 21 of the trailer 20. With that the door 30 has rotated at least substantially 360 degrees from the inward position adjacent to, and substantially parallel to, the interior side 25 of the side wall 21 of the trailer 20 as illustrated in FIG. 16 to the outward position adjacent to the opposite exterior side 27 of the side wall 21 of the trailer 20 as illustrated in FIG. 18. Such a rotation is not possible without the sigmoid, or S-shape, construction 111 of the connecting plate 108. The prior art hinges for semi-trailers 20 do not possess the sigmoid, or S-shape, construction 111, and as a result are unable to rotate doors of tractor trailers in a substantial 360 degree rotation. In doing so, the joint 40′″ is housed partially within the trailer 20 when the doors 30 are in the closed position, see FIG. 15. Thus, the joint (40, 40′, 40″, 40″′) of the present invention further addresses the need for a joint assembly having a reduced exposure to the environment, reducing the possibility of environmental damages to the joints due to the compact design and integration of the design with the semi-trailer 20.

One drawback of the present invention 10 may be the presence of cargo (not shown) in the interior 24 of the trailer 20 that may prevent the doors 30 from swinging in the inward direction shown in FIG. 8A. In the case of a trailer 20 that is fully loaded or substantially fully loaded with cargo (often referred to as “cubed out”), the driver may have to open the doors 30 in the outwardly swinging direction at the first dock (or first few docks) where cargo is to be unloaded. Once a sufficient amount of cargo has been removed from the interior of the trailer 20, then the trailer doors 30 can be swung in the inward direction at the following docks to unload additional cargo.

Likewise, if an empty trailer 20 is being loaded with an amount of cargo that will not completely fill the trailer 20, the trailer may be backed to the loading dock 70, see FIG. 8A, without the need for the driver to stop and open the trailer doors 30 prior to backing against the loading dock 70, see FIG. 8A. The trailer doors 30 may be opened in the inward direction (as shown in FIGS. 8B and 8C) after the trailer 20 is positioned at the loading dock 70, see FIG. 8A.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the claims.

I/We claim:

1. A door system for a semi-trailer, with said semi-trailer defined by at least one substantially vertical semi-trailer side wall with an interior side and an opposite exterior side, said door system comprising:
a door frame defined by said side wall;
said door frame having a face substantially perpendicular to said side wall;
at least one door having a door interior side and a door exterior side;
at least one movable joint in coupled communication with said door frame face and said door;
said at least one joint having a first pivot point and a second pivot point;
said first pivot point and said second pivot point pivotally connected with a sigmoid shaped connector; and
said door pivotally positioned from a first position with said door interior side adjacent to and substantially parallel to said semi-trailer side wall interior side to a second position with said door exterior side adjacent to and substantially parallel to said semi-trailer side wall exterior side.

2. The door system of claim 1 wherein a plurality of said at least two joints are in coupled communication with said door and said door frame face.

3. The door system of claim 1 wherein said first pivot point and said second pivot point are offset in a longitudinal direction with respect to said side wall.

4. The door system of claim 1 wherein said first pivot point is offset in a first traverse direction with respect to said sidewall.

5. The door system of claim 4 wherein said second pivot point is offset in a second traverse direction, opposite said first traverse direction.

6. The door system of claim 1 wherein said sigmoid connector having a first bend extended towards said first pivot point.

7. The door system of claim 6 wherein said sigmoid connector having a second bend extended opposite said first bend towards said second pivot point.

8. The door system of claim 7 wherein at least one of said first bend and said second bend is defined by at least one of a crescent shape and an angular extension.

9. In a door system for a semi-trailer comprising:
a door frame defined by at least one substantially vertical semi-trailer side wall, with said side wall having an interior side and an opposite exterior side;
said door frame having a face substantially perpendicular to said side wall;
at least one door having a door interior side and a door exterior side;
at least one joint, with a first pivot point and a second pivot point, in coupled communication with said door frame face and said door;
the improvement comprising:
said first pivot point and said second pivot point pivotally connected with a sigmoid shaped connector; and
said door pivotally positioned from a first position with said door interior side adjacent to and substantially parallel to said semi-trailer side wall interior side to a second position with said door exterior side adjacent to and substantially parallel to said semi-trailer side wall exterior side.
